(19) United States
(12) Patent Application Publication
(10) Pub. No.: US 2015/0132143 A1
(43) Pub. Date: May 14, 2015

(54) WELDING PROCESS AND REDUCED RESTRAINT WELD JOINT

(71) Applicants: Gerald J. Bruck, Oviedo, FL (US); Ahmed Kamel, Orlando, FL (US)

(72) Inventors: Gerald J. Bruck, Oviedo, FL (US); Ahmed Kamel, Orlando, FL (US)

(21) Appl. No.: 14/076,465

(22) Filed: Nov. 11, 2013

(51) Int. Cl. B23K 31/02

(52) U.S. Cl. CPC B23K 31/02
USPC 416/241 R; 228/256; 228/165; 403/272

(57) ABSTRACT

A weld joint (30) having asymmetric sides and providing reduced restraint of weld metal shrinkage and a reduced propensity for weld centerline cracking. The weld joint may have a first side (38) formed at an angle (A₁) of 35-60° relative to the component surface (36), and a second side (40) formed at an angle (A₂) of 10-35° relative to the surface. The sides may be extended to intersect (44) without the necessity for a flat bottom surface (20) as is typical for prior art weld joints (10). The inventive weld joint may be formed by moving an end mill tool (60) into and along the surface with its axis of rotation (64) being transverse to the surface.

### FIELD OF THE INVENTION

This application relates generally to the field of materials technology, and more particularly to the field of welding, and in particular applications to the weld repair of superalloy components.

### BACKGROUND OF THE INVENTION

It is recognized that superalloy materials are among the most difficult materials to weld due to their susceptibility to weld solidification cracking and strain age cracking. The term “superalloy” is used herein as it is commonly used in the art; i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys.

Weld repair of some superalloy materials has been accomplished successfully by preheating the material to a very high temperature (for example to above 1600° F. or 870° C.) in order to significantly increase the ductility of the material during the repair. This technique is referred to as hot box welding or superalloy welding at elevated temperature (SWET) weld repair, and it is commonly accomplished using a manual GTAW process. However, hot box welding is limited by the difficulty of maintaining a uniform component process surface temperature and the difficulty of maintaining complete inert gas shielding, as well as by physical difficulties imposed on the operator working in the proximity of a component at such extreme temperatures.

Some superalloy material welding applications can be performed using a chill plate to limit the heating of the substrate material; thereby limiting the occurrence of substrate heat affects and stresses causing cracking problems. However, this technique is not practical for many repair applications where the geometry of the parts does not facilitate the use of a chill plate.

The present inventors have developed a superalloy welding technique using powdered flux and metal as disclosed in United States Patent Application Publication No. US 2013/0140278 A1, incorporated by reference herein. That process facilitates the deposition of even the most difficult to weld superalloys. However, further improvements are desired for the weld repair of superalloy material components.

### BRIEF DESCRIPTION OF THE DRAWINGS

The invention is explained in the following description in view of the drawings that show:

FIG. 1 is a sectional view of a prior art weld joint.

FIG. 2 is a sectional view of a weld joint in accordance with an embodiment of the invention.

FIG. 3 illustrates a process of forming a weld prep using an end mill tool in accordance with an embodiment of the invention.

FIG. 4 is a top view of a gas turbine engine blade having weld preps formed in accordance with embodiments of the invention.

### DETAILED DESCRIPTION OF THE INVENTION

The inventors have recognized that difficulties in the weld repair of superalloy materials are exacerbated because known weld joint geometries tend to restrain the weldment as it cools and solidifies. FIG. 1 illustrates a typical prior art component repair weld joint 10 generally having a weld prep with a flat bottom V cross-sectional shape. The weld joint 10 of FIG. 1 is typically used during the repair of a component when a crack or other discontinuity is excavated from a substrate 12 by removing material from a surface 14 to a depth necessary to remove the discontinuity (not shown). Additional material is then removed to form the flat bottom V shape weld prep 16 having opposed sloping sides 18, 18′, extending to a generally flat bottom surface 20. The flat bottom surface 20 is necessary instead of extending the sides 18, 18′ to join together at a point in order to ensure complete fusion at the bottom of the weld. Weld metal 22 is then added in one or more passes to fill the weld prep 16, such as by the laser melt deposition of powdered superalloy material or other known process.

When molten weld metal 22 is deposited into the weld prep 16, it cools and solidifies by heat loss primarily to the adjoining substrate material 12 along sides 18, 18′. A thin layer 24 of material along the sides 18, 18′ may melt or become heat affected as the heat transfer occurs and the heat energy dissipates into the substrate 12, resulting in a temperature gradient through the weld metal 22. The molten material will begin to solidify along the sides 18, 18′ as a result of the temperature gradient, and solidification will progress inwardly from both sides 18, 18′ toward the center of the weld metal 22. As the metal solidifies and cools, it shrinks. The first-solidified material proximate sides 18, 18′ is restrained by the relative structural rigidity of the substrate 12, and thus, the shrinkage must be accommodated by the remaining solidifying weld metal 22 itself. As a result of the inwardly progressing solidification fronts progressing toward the center of the weld joint 10 from both sides 18, 18′, there develops a central region of the weld metal 22 that is under significant tensile stress, sometimes resulting in centerline shrinkage cracking 26. Even if solidification cracking does not occur, the geometry and high resulting restraint promote elevated residual weld stresses. Such stresses can compound with stresses from post weld age hardening and result in strain age cracking.

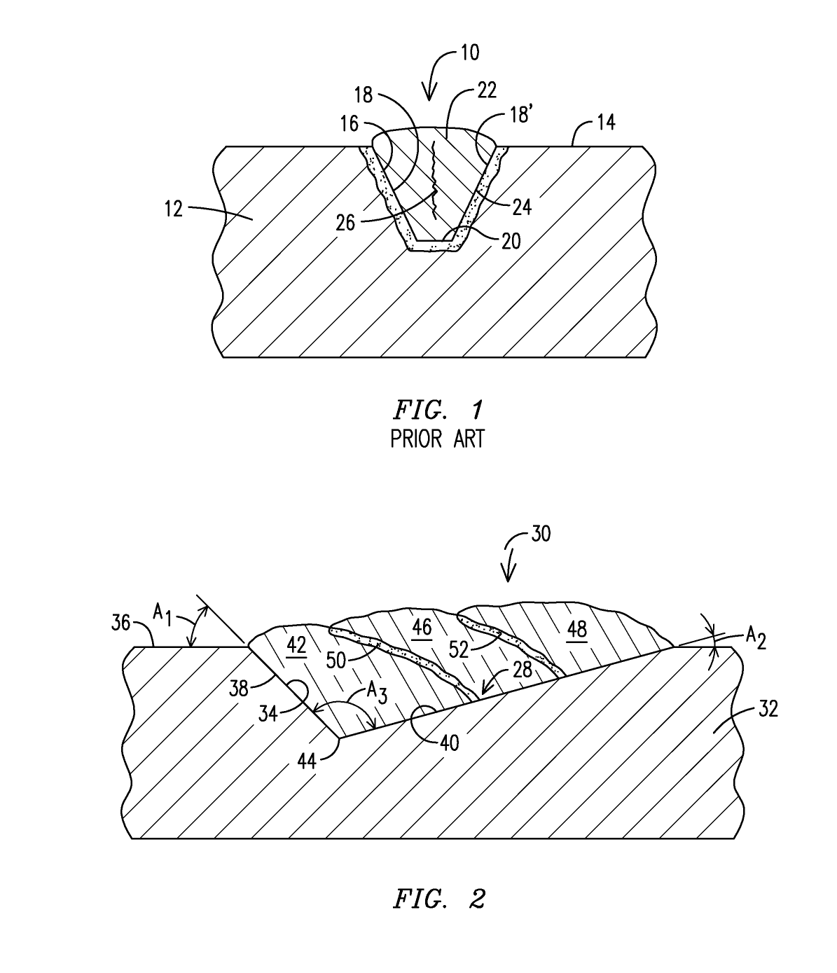

The present inventors first disclose an asymmetric weld prep and welding process which reduce the magnitude of centerline shrinkage stress in a weld joint, thereby reducing the likelihood of centerline shrinkage cracking. One embodiment of the invention is illustrated in FIG. 2, where a tapered groove weld joint 30 is formed in a substrate 32. In this embodiment, tapered groove weld prep 34 is formed in a surface 36 of the substrate 32 to have opposed sides 38, 40 each formed at a different respective angle A₁, A₂ relative to a plane of the surface 36. In the embodiment illustrated, side 38 is formed at a 45° angle relative to the surface 36, and side 40 is formed at a 15° angle relative to the surface 36.

In a welding process utilizing the weld prep 34, a first pass (or bead or layer) of weld metal 42 is deposited to form a bottommost portion of the weld joint 30 encompassing the point of intersection 44 of the sides 38, 40. As the molten material of the first pass of weld metal 42 cools and solidifies, the shrinkage strain is relatively more constrained by side 38 while it is relatively less constrained by side 40 due to its flatter angle relative to the plane of the surface 36, and the resulting greater angle between the converging solidification fronts. As a result, the shrinkage is better accommodated by the solidifying weld metal since it is relatively more free to displace in response to the shrinkage, and the magnitude of shrinkage strain developed at the centerline of the first pass 42 is lower than is experienced with a first pass in the prior art weld joint 10 of FIG. 1. Furthermore, because the angle A₃ of intersection of the sides 38, 40 that is filled by the first pass 42 is relatively wide, complete fusion can be achieved at the point of intersection 44 without the necessity for forming a flat area at the bottom of the weld prep 34 as is typically necessary in the prior art.

A relatively flatter excavation angle requires more material removal for a given maximum depth of the weld prep excavation, and thus, it is desired to maximize the angle relative to the surface 36 for both sides 38, 40 while at the same time achieving a desired reduced degree of restraint for the joint 30 compared to prior art joints. For the laser deposition of crack-prone powdered superalloy materials as are commonly used in gas turbine engine applications, angle A₁ may be in the range of 35-60° and angle A₂ may be in the range of 10-35°. Angle A₃ is 120° in the embodiment of FIG. 2 and may be in the range of 85-135° in other embodiments where no flat bottom is formed at the bottom of the weld prep.

If the weld metal 42 is deposited with an energy beam powder melting process, it may be desired to direct the energy beam into the weld prep 34 at an angle that bifurcates angle A₃. Moreover, it may be desired to tilt surface 36 to an off-horizontal angle such that the energy beam is vertical as it bifurcates the angle A₃, thereby facilitating the control of the powder and weld pool during the deposition process. For example, such tilting would, by way of gravity and surface tension, promote the molten pool to be relatively symmetric about the vertical beam axis and to minimize otherwise asymmetric forces of restraint.

The embodiment of FIG. 2 illustrates the use of a second pass 46 and a third pass 48 of weld metal in order to completely fill weld prep 34, with a thin layer of re-melted material 50, 52 being formed between the respective passes. It is noted that a thin layer of the substrate material must also be melted to cause fusion during the welding process, but for the purposes of simplifying discussions herein, and consistent with the practicalities of implementation of the invention, the weld prep surfaces 38, 40 are presumed to remain essentially unchanged throughout the welding steps. The surface of the first pass 42 where it intersects side 40 near region 28 is generally parallel to side 38, thus the stress minimizing benefit of the side surface angles of the invention continues with each successive pass 46, 48.

Material excavation during a repair process is often done with a hand held grinding tool, but in a factory setting such as is typical for a gas turbine component repair facility, the excavation can be done with machine tools. The inventors have found that weld preps in accordance with embodiments of the invention can be conveniently formed with an end mill tool. FIG. 3 illustrates a step in the repair of a component 56 wherein a weld prep 58 is formed by moving an end mill tool 60 into the component surface 62 with its axis of rotation 64 transverse to the surface 62 such that a direction of forward motion 66 of the end mill tool 60 defines the angle A₁ of the first side 68 of the weld prep 58, and an orientation of a cutting surface 70 of the end mill tool 60 defines the angle A₂ of the second side 72 of the weld prep 58. The shape of the end mill tool 60 may be selected to achieve any desired weld prep geometry, including with or without a flat bottom surface.

The end mill tool 60 may be moved into the surface 62 in direction 66 to whatever depth is necessary to remove discontinuities and/or to achieve a desired depth of the weld prep 58. The end mill tool 60 may then also be moved in a direction parallel to the surface 62 (i.e. into or out of the paper in FIG. 3) to extend the excavation in a linear dimension and to create a longitudinal dimension for the weld prep 58. Movement parallel to the surface 62 may be linear, curvilinear or a combination thereof as may be desired for a particular repair geometry for a component.

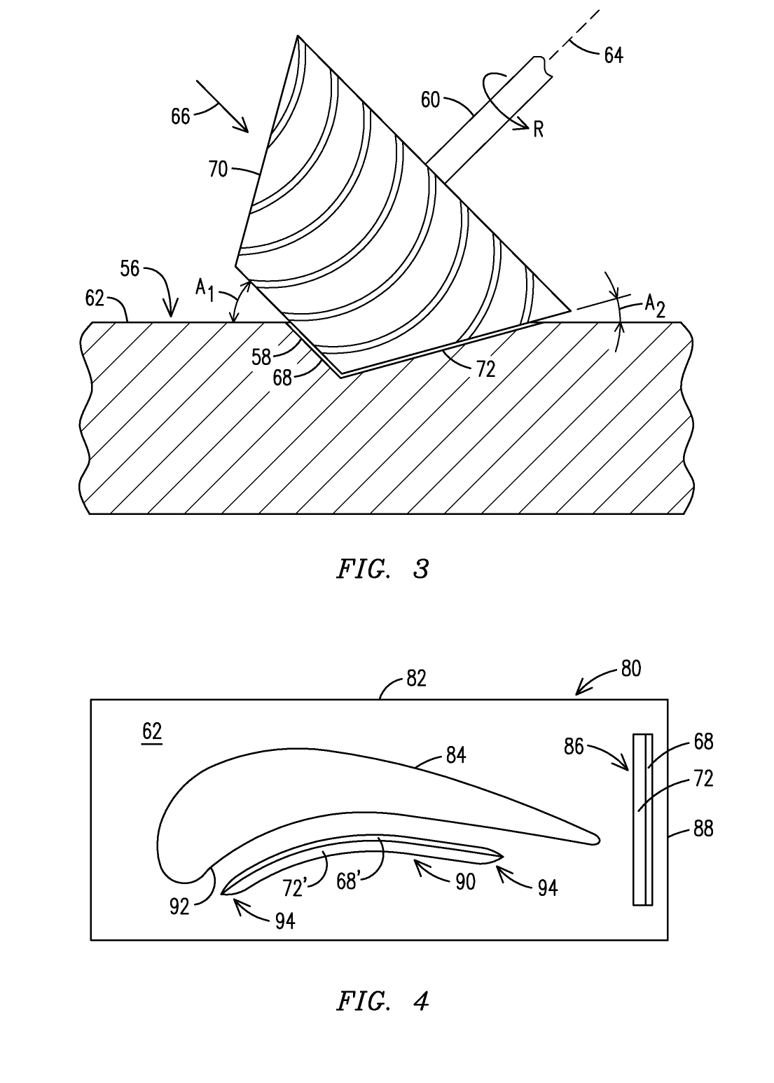

FIG. 4 is a top view of a gas turbine engine blade 80 having a platform 82 and an airfoil 84 extending upwardly from the platform 82. The platform 82 has a top surface 62 corresponding to surface 62 of FIG. 3. Two areas of repair of the platform 82 are illustrated. A first linear weld prep 86 is formed proximate an edge 88 of the platform 82. Weld prep 86 may be formed as illustrated in FIG. 3 by moving the end mill tool 60 linearly parallel to the edge 88 after it has been inserted into the surface 62 to a desired depth. Movement parallel to the edge 88 creates the longitudinal length of first side 68 and second side 72 of the weld prep 86.

A second curvilinear weld prep 90 is formed proximate a pressure side 92 of the airfoil 84 by moving the end mill tool 60 generally parallel to the pressure side 92 to form the longitudinal length of first surface 68′ and second surface 72′. Second weld prep 90 is formed to have a constant depth along most of its central length, but then tapering in depth to zero depth proximate each longitudinal end 94. As the end mill tool 60 is being inserted into the surface 62 in direction 66, it is also being moved parallel to the pressure side 92. As the depth of penetration of the tool 60 increases, the maximum depth and size of sides 68′ and 72′ increase. The reverse of this process is accomplished at the opposite longitudinal end as the tool 60 is withdrawn from the surface 62, thereby providing a desired taper to the weld prep 90 at both opposed ends 94 while maintaining the desired side angles A₁, A₂. For high volume components routinely repaired to reverse the effects of operational degradation that is similar for all such components, such machining is conveniently programmed on computer controlled machines. Furthermore, the subsequent weld repair of the components may also be conveniently programmed on computer controlled welding machines, facilitating the reduced cost repair of difficult to weld superalloy components such as gas turbine engine blades.

While various embodiments of the present invention have been shown and described herein, it will be obvious that such embodiments are provided by way of example only. Numerous variations, changes and substitutions may be made without departing from the invention herein. For example, while the surface of the material being welded is illustrated as planar, one will appreciate that all such surfaces are not strictly planar but may be generally planar or somewhat curved. As used herein, the angle of the weld prep sides relative to the surface may be considered as being measured relative to a plane that approximates the actual surface or a tangent to the surface within the scope of the invention. It is intended that the invention be limited only by the spirit and scope of the appended claims.

The invention claimed is:

1. An apparatus comprising:
a substrate comprising a surface;
a weld prep formed into the surface and comprising opposed first and second sides in cross section;
the first side disposed at a first angle relative to the surface and the second side disposed at a second angle different than the first angle relative to the surface; and
weld metal deposited into the weld prep and joining the first and second sides.

2. The apparatus of claim 1, wherein the first side is disposed at an angle relative to the surface of 35-60° and the second side is disposed at an angle relative to the surface of 10-35°.

3. The apparatus of claim 1, wherein the first side is disposed at an angle relative to the surface of 45° and the second side is disposed at an angle relative to the surface of 15°.

4. The apparatus of claim 1, further comprising the first and second sides extending to intersect at a bottom of the weld prep.

5. The apparatus of claim 1, further comprising the weld prep extending in a longitudinal direction on a curvilinear path along the surface.

6. The apparatus of claim 1, further comprising:
the weld prep extending to have a longitudinal length along the surface;
the weld prep having a first depth proximate a central portion of the longitudinal length; and
the weld prep tapering to a second depth less than the first depth proximate at least one end of the longitudinal length.

7. The apparatus of claim 1 formed in a surface of a superalloy gas turbine component and being free of centerline shrinkage cracking.

8. A method comprising:
forming a weld prep in a surface to have first and second sides disposed at different angles relative to the surface in cross section; and
filling the weld prep with weld metal to join the first and second sides.

9. The method of claim 8, further comprising forming the first side at an angle relative to the surface of 35-60° and forming the second side at an angle relative to the surface of 10-35°.

10. The method of claim 8, wherein the first side is formed at an angle relative to the surface of 45° and the second side is formed at an angle relative to the surface of 15°.

11. The method of claim 8, further forming the first and second sides to extend to intersect at a bottom of the weld prep.

12. The method of claim 8, further comprising forming the weld prep to extend in a longitudinal direction on a curvilinear path along the surface.

13. The method of claim 8, further comprising:
forming the weld prep to extend to have a longitudinal length along the surface;
forming the weld prep to have a first depth proximate a central portion of the longitudinal length and to have a second depth less than the first depth proximate at least one end of the longitudinal length.

14. The method of claim 8, further comprising forming the weld prep by moving an end mill tool into the surface with its axis of rotation transverse to the surface such that a direction of motion of the end mill tool into the surface defines an angle relative to the surface of the first side of the weld prep, and an orientation of a cutting surface of the end mill tool defines an angle relative to the surface of the second side of the weld prep.

15. A method comprising:
excavating material including a discontinuity from a region of a surface of a component;
forming a weld prep in the region to have opposed sides disposed at different respective angles relative to the surface in cross section; and
depositing weld metal into the weld prep in one or more passes to join the opposed sides.

16. The method of claim 15, further comprising:
forming a first side of the weld prep to be disposed at an angle relative to the surface of 35-60°; and
forming a second side of the weld prep to be disposed at an angle relative to the surface of 10-35°.

17. The method of claim 15, further comprising forming the weld prep by moving an end mill tool into the surface with its axis of rotation transverse to the surface such that a direction of motion of the end mill tool into the surface defines an angle relative to the surface of a first side of the weld prep, and an orientation of a cutting surface of the end mill tool defines an angle relative to the surface of a second side of the weld prep.

18. The method of claim 17, further comprising moving the end mill tool along the surface to extend the weld prep along a longitudinal path.

19. The method of claim 18, wherein the longitudinal path is curvilinear.

20. The method of claim 15, wherein the component is formed of superalloy material, and further comprising laser depositing superalloy material powder into the weld prep to join the opposed sides without centerline shrinkage cracking.
